(19) United States
(12) Patent Application Publication
(10) Pub. No.: US 2013/0181373 A1
(43) Pub. Date: Jul. 18, 2013

(54) PROCESS FOR THE PRODUCTION OF A FIBER COMPOSITE COMPONENT OR HYBRID COMPONENT, AND ARRANGEMENT THEREFOR

(71) Applicant: ENGEL AUSTRIA GmbH, Schwertberg (AT)

(72) Inventors: Alexander STOCK, Linz (AT); Peter EGGER, Perg (AT)

(73) Assignee: ENGEL AUSTRIA GMBH, Schwertberg (AT)

(21) Appl. No.: 13/743,685

(22) Filed: Jan. 17, 2013

(30) Foreign Application Priority Data
Jan. 18, 2012 (AT) A 51/2012

(51) Int. Cl. B29C 45/14

(52) U.S. Cl. CPC B29C 45/14008
USPC 264/257; 425/126.1

(57) ABSTRACT

A process and an arrangement for the production of a fiber composite or hybrid component comprising a preparation station in which an insert portion can be processed, a closing unit of an injection molding machine, having a cavity in which the processed insert portion is or can be arranged, an injection unit of the injection molding machine for the injection of molten plastic material into the cavity, with injection thereof around the insert portion arranged in the cavity, and a transport device by which the insert portion can be transported into the preparation station and into the cavity of the closing unit, wherein the insert portion remains in connected relationship with the transport device during processing in the preparation station, during transport to the closing unit and during injection therearound in the cavity.

The invention concerns a process for the production of a fiber composite component or hybrid component comprising the steps: processing an insert portion in a preparation station, transporting the insert portion with a transport device from the preparation station into a cavity of a closing unit of an injection molding machine, injecting around the insert portion with molten plastic material, which is introduced into the cavity by an injection unit of an injection molding machine, in order to build the fiber composite component or hybrid component, and removing the fiber composite or hybrid component together with insert portion from the closing unit by a transport device. The invention additionally concerns an arrangement for the production of a fiber composite or hybrid component, comprising a preparation station in which an insert portion can be processed, a closing unit of an injection molding machine, having a cavity in which the processed insert portion is or can be arranged, an injection unit of the injection molding machine for the injection of molten plastic material into the cavity, in order to inject the plastic material around the insert portion arranged in the cavity, and a transport device by which the insert portion can be transported into the preparation station and into the cavity of the closing unit.

The production of multi-component injection moldings has greatly increased in recent years. In particular there is an increased demand for fiber-reinforced injection molded components. In that case so-called fiber composite components or hybrid components are generally produced from pre-fabricated or pre-consolidated parts in which there is already a fiber structure. The so-called fiber composite or hybrid components can also be referred to as organic sheets or pre-pregs. The production of fiber composite or hybrid components involves the introduction of reinforcing or functionalization elements (so-called inserts or insert portions).

The handling concepts known from the state of the art are complicated technically and in respect of time, in particular for introduction of those insert portions. An example of the production of such composite or hybrid structures can be found in DE 10 2010 019 625 A1. A further process for the production of a reinforced composite product is disclosed in WO 2009/019102 A1. In addition the relatively great complication and expenditure in production and the large amount of space required for the necessary handling robots have proven to be disadvantageous in those processes. In addition, the fact of the insert portions being gripped by the handling robots can give rise to unwanted deformation or even destruction of the weave or fiber structure.

The object of the present invention was therefore that of providing a process and an arrangement which are improved over the state of the art. In particular the invention seeks to achieve simplified production of a fiber composite or hybrid component, in which the insert portions are moved as exactly and uninfluencedly as possible.

That is achieved for a process having the features of the classifying portion of claim 1 and an arrangement having the features of the classifying portion of claim 5, in that the insert portion remains in connected relationship with the same transport device during processing in the preparation station, during transport to the closing unit and during injection in the cavity. Accordingly the insert portion does not have to be gripped by various handling robots, but the insert portion always remains fixed to the transport device or is resting thereon. The transport device thus forms a conveyor system for transporting 2D and/or 3D-textile structures (insert portions) which are pre-laid, applied partially or over the full surface area, consolidated or unconsolidated.

The present invention also makes it possible to provide a continuous handling concept—without transfers or large displacement travel paths—and the cycle time for the production of the fiber composite or hybrid components is considerably reduced. In other words the transport device passes both through the preparation station and also through the closing unit and thus forms the basis for a production line for the production of a fiber composite or hybrid component. Building further on the idea of the production line, the transport device with its items being transported (insert) passes through all process steps in the production of the fiber composite or hybrid component, which consist of at least two constituent parts, of which at least one constituent part has to be introduced from the outside into the actual displacement unit. That constituent part is transported with the transport device.

It can preferably be provided that the transport device has a conveyor belt, by way of which the insert portion is transported. In that case the insert portion can lie on the conveyor belt in an unfixed condition or loosely. Preferably however the insert portion is directly connected to the conveyor belt. It can however also be provided that the insert portion can be fixed to the conveyor belt by way of a carrier or gripper. The connection between the insert portion and the transport device can preferably be of positively locking, force-locking or bonded nature.

For providing an efficient configuration for the transport device it can be provided that the conveyor belt is a circulatory belt. That circulatory component of the conveyor device can be either a one-part or a two-part component. The insert can be connected directly to the conveyor device or can be mounted on a carrier which is conveyed or which is itself the conveyor device. In the last case the carrier which in fact at the same time forms the transport device would have to be separated again from the applied additional constituent part (second insert portion) or from the finished component or would have to be left in the fiber composite or hybrid component by cutting off from the rest of the transport device formed by the insert portion. If the transport device is a deformable film it can remain even until the shaping operation in the tool or also in the fiber composite or hybrid component, after the textile reinforcing structures have been drawn in and shaped.

Besides the actual displacement unit (injection molding machine with closing unit and injection unit) the transport system also passes through a preparation station and preferably also a post-processing station. Depending on the respective component to be produced and the respective procedure involved, additional working steps are performed here. The feed in that case can be horizontal or vertical. Likewise the closing unit can be a horizontal or a vertical unit. It will be appreciated that intermediate positions (for example 45° or 30°) are also conceivable. Basically the cavity in the tool can also be filled outside the axis of closing movement of the closing unit of the injection molding machine. For that purpose the tool can be moved out of the region of the closing unit.

Process steps which can be carried out in the preparation station are insertion of the insert portion, fitment of the insert portion with an additional constituent part, drying the insert portion, heating or softening the insert portion, impregnating the insert portion, binding and/or spraying on an adhesive, and so forth. For production of fiber-reinforced hybrid components it is particularly preferably provided that the preparation station has a heating device by which the preferably pre-consolidated insert portion can be softened. With this variant the present invention has the particular advantage that the fact that the insert portion remains on the transport device means that the insert portion which becomes more flexible and more unstable nonetheless remains reliably held to the transport device as is wanted, and thus passes in the desired form from the preparation station into the closing unit.

To achieve an arrangement which can be used in multi-functional manner and a process which is complete as possible for the production of a fiber composite or hybrid component, a post-processing station for processing the fiber composite or hybrid component is preferably provided after the operation of injecting molten plastic material around the insert portion, in which case the insert portion also remains in connected relationship with the transport device in the post-processing station. The post-processing steps which can be carried out here are cutting, cooling, drying and/or burr removal, and so forth.

A 2D- or 3D-textile structure which is laid over the full surface area or partially on the transport device can serve as the insert portion. For example such textile structures can be in the form of monofilament yarn, multifilament yarn, coated yarn, twine, gimped yarn, friction spun yarn, wrapped yarn with a central reinforcing fiber (for example glass fiber), textile fabric, biaxial textile, multiaxial textile, 3D-braid, round braid, triaxial round textile, spacer or contour fabric, non-woven fabric or the like. The fibers used for production of the textile structures can be glass fibers, carbon fibers, basalt fibers, aramid fibers, polymer fibers or also hybrid yarns (glass fibers and thermoplastic fibers). Insert portions can however also be consolidated semifinished items (organic sheets, tapes, pre-pregs and so forth) of fiber composite materials.

Resins (RTM—resin transfer molding) or low-viscosity reactive polymer substances (RIM—reaction injection molding, insitu polymerization of PA) are used for the infiltration and impregnation of unconsolidated textile structures. Injection assemblies for the injection of molten thermoplastic materials are used for injecting functional elements around and on to consolidated semifinished items. Thus resins, reactive polymer substances and molten thermoplastic materials or molten plastic materials can be interpreted as introduced or injected plastic constituent parts (these can also be referred to as starting components) in accordance with the invention.

Further details and advantages of the present invention are described more fully hereinafter by means of the specific description with reference to the embodiments by way of example illustrated in the drawings in which:

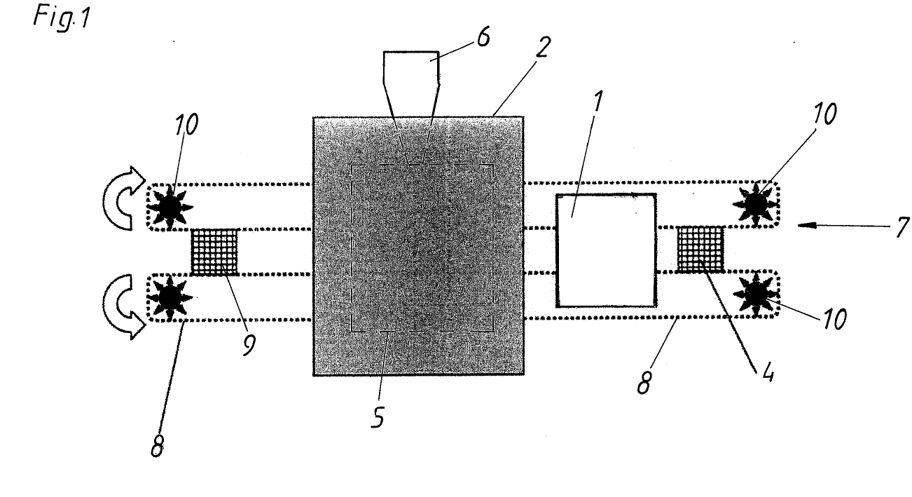

FIG. 1 diagrammatically shows an arrangement with closing unit, injection unit, preparation station and transport device,

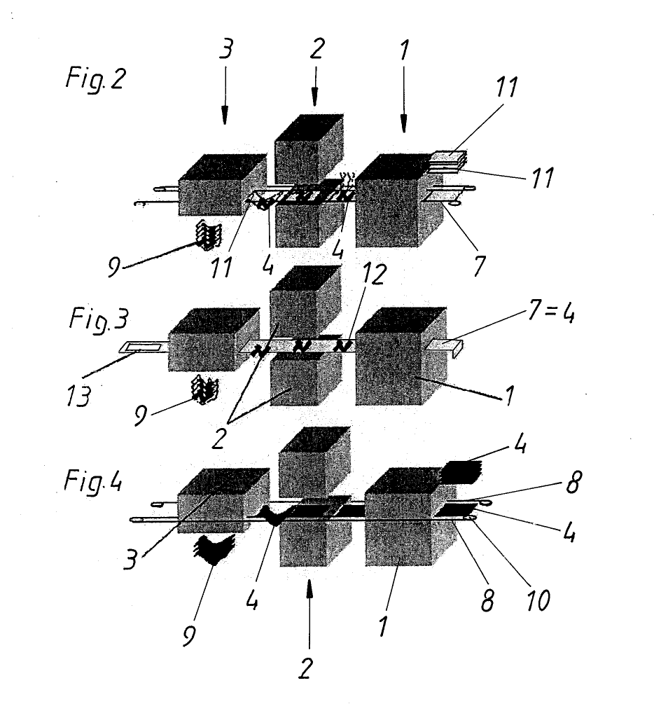

FIG. 2 shows an arrangement with a transport device together with a conveyor belt,

FIG. 3 shows an arrangement with a transport device formed by the insert portion itself, and

FIG. 4 shows insert portions connected directly to the conveyor belt.

FIG. 1 shows the essential component parts for carrying out a process for the production of a fiber composite or hybrid component 9. In this case the transport device 7 passes on the one hand through the preparation station 1 and on the other hand through the closing unit 2. The transport device 7 has two conveyor belts 8 driven by drive devices 10. An insert portion 4 is fixed or clamped between the two conveyor belts 8 before or upon reaching the preparation station 1. That pre-consolidated insert portion which has a woven fabric or a fiber structure (for example with endless glass fibers) passes into the preparation station 1 due to the movement of the conveyor belt 8. Provided in that preparation station 1 is a heating device which heats and thereby softens the insert portion 4. That can additionally be effected by pressure. Subsequently the insert portion 4 which has still remained on the transport device 7 passes into the closing unit 2, in the tool of which there is a cavity 5. The fiber composite or hybrid component 9 is formed by molten plastic material being injected into the cavity 5 by way of the injection unit 6. When a thermoplastic material is injected that is formed by cooling down or when a thermosetting material is injected the fiber composite or hybrid component 9 is finished by curing reaction. After the further movement of the insert portion 4 or fiber composite or hybrid component 9 which has still remained on the transport device 7, the insert portion 4 or the component 9 goes to the end of the production line, where it can be removed or suitably subjected to further processing or stored.

FIG. 2 diagrammatically shows an arrangement with a preparation station 1, a closing unit 2 and a post-processing station 3. In this embodiment the transport device 7 comprises two conveyor belts 7 at both sides, between which a carrier 11 is clamped. An insert portion 4 is applied and heated on that carrier 11 in the preparation station 1. After that the heated insert portion 4 which is resting on the carrier 11 passes into the closing unit 2 where material is injected therearound. Subsequently post-processing is also effected for example by cooling in the post-processing station 3, whereupon the produced fiber composite or hybrid components 9 can be deposited or stacked.

In FIG. 3 the insert portion 4 itself forms the transport device 7 and is guided for example by a roller (not shown here) in web form through the preparation station 1, closing unit 2 and post-processing station 3. In the region of the preparation station 1 an additional constituent part 12 (for example metallic reinforcement member) is laid thereon and the insert portion 4 in web form passes together with the additional constituent 12 into the cavity 5 of the vertical closing unit 2. Finally, in the post-processing station 3, the region which has had material injected therearound is stamped out of the web of the insert portion 4 together with the additional constituent part 12, thereby resulting in the hole 13 in the transport device 7.

In FIG. 4 the insert portion 4 is fixed directly to the conveyor belts 8 of the transport device 7. The conveyor belts 8 thus form a kind of clamping frame for the insert portions 4. The transport device 7 is moved by the drive device 10 and the insert portions 4 pass successively for processing thereof into the preparation station 1, the closing unit 2 and the post-processing station 3.

The present invention thus provides an improved process and an improved arrangement for the production of a fiber composite or hybrid component 9, wherein the technical and time involvement is reduced in comparison with the state of the art by a constituent part (insert portion 4 or additional constituent part 12) of the fiber composite or hybrid component 9 to be produced being always fixed to the transport device 7 or resting thereon, throughout the entire production process. Therefore there is no need to provide for complicated and involved transfers with susceptibility to damage, of the insert portion 4 between the individual stations 1, 2 and/or 3 of the production procedure.

1. A process for the production of a fiber composite component or hybrid component comprising the steps:
processing an insert portion in a preparation station,
transporting the insert portion with a transport device from the preparation station into a cavity of a closing unit of an injection molding machine,
injecting around the insert portion with a plastic component, preferably a molten plastic material, which is introduced into the cavity by an injection unit of an injection molding machine, in order to build the fiber composite component or hybrid component, and
removing the fiber composite or hybrid component together with the insert portion from the closing unit by a transport device,
characterized in that the insert portion remains in connected relationship with the same transport device during processing in the preparation station, during transport to the closing unit and during injection therearound in the cavity.

2. A process as set forth in claim 1 characterized in that the transport device has a conveyor belt by way of which the insert portion is transported.

3. A process as set forth in claim 1 characterized in that the preparation station has a heating device by which the preferably pre-consolidated insert portion is softened.

4. A process as set forth in claim 1 characterized in that in a post-processing station the fiber composite component or hybrid component is processed after the step of injecting around the insert portion with molten plastic material, wherein the insert portion also remains in connected relationship with the transport device in the post-processing station.

5. An arrangement for the production of a fiber composite component or hybrid component, in particular for carrying out a process as set forth in claim 1, comprising
a preparation station in which an insert portion can be processed,
a closing unit of an injection molding machine, having a cavity in which the processed insert portion is or can be arranged,
an injection unit of the injection molding machine for the injection of a plastic component, preferably molten plastic material, into the cavity, in order to inject the plastic component around the insert portion arranged in the cavity, and
a transport device by which the insert portion can be transported into the preparation station and into the cavity of the closing unit,
characterized in that the insert portion remains in connected relationship with the transport device during processing in the preparation station, during transport to the closing unit and during injection of the molten plastic material around the insert portion.

6. An arrangement as set forth in claim 5 characterized in that the transport device has a conveyor belt by way of which the insert portion is transported.

7. An arrangement as set forth in claim 6 characterized in that the insert portion is connected directly to the conveyor belt.

8. An arrangement as set forth in claim 6 characterized in that the insert portion can be fixed to the conveyor belt by way of a carrier or gripper.

9. An arrangement as set forth in claim 6 characterized in that the conveyor belt is adapted to circulate.

10. An arrangement as set forth in claim 6 characterized in that the conveyor belt itself forms the insert portion.

11. An arrangement as set forth in claim 5 characterized in that the preparation station has a heating device by which the preferably pre-consolidated insert portion can be softened.

12. An arrangement as set forth in claim 5 characterized by a post-processing station for processing the fiber composite component or hybrid component after injection around the insert portion with molten plastic material, wherein the insert portion also remains in connected relationship with the transport device in the post-processing station.
